(19) United States
(12) Patent Application Publication
(10) Pub. No.: US 2024/0288690 A1
(43) Pub. Date: Aug. 29, 2024

(54) OPTICAL DISPLAY SYSTEM AND ELECTRONICS DEVICE

(71) Applicants: University of Central Research Foundation, Inc., Orlando, FL (US); Goertek Inc., Weifang, Shandong (CN)

(72) Inventors: YANNANQI LI, Orlando, FL (US); Jianghao Xiong, Orlando, FL (US); Qian Yang, Oviedo, FL (US); Kun Li, Santa Clara, CA (US); Shin-Tson Wu, Orlando, FL (US)

(73) Assignees: University of Central Florida Research Foundation, Inc., Orlando, FL (US); Goertek Inc., Weifang, Shandong (CN)

(21) Appl. No.: 18/572,899

(22) PCT Filed: Jun. 21, 2022
(86) PCT No.: PCT/CN2022/100158

§ 371 Date: Dec. 21, 2023

Related U.S. Application Data
(60) Provisional application No. 63/212,747, filed on Jun. 21, 2021.

(51) Int. Cl. G02B 27/01; G02B 27/12; G02B 27/28

(52) U.S. Cl. CPC G02B 27/0101; G02B 27/123; G02B 27/281

(57) ABSTRACT

Here discloses an optical display system and an electronics device. The optical display system comprises: image-generating display; controllable polarization rotator module, which receives light from the image-generating display and outputs the light into polarized light with a first polarization and/or a second polarization under control; a first reflective lens, which reflects the polarized light with a first polarization to a pupil of an observer; and a second reflective lens, which reflects the polarized light with a second polarization to the pupil, wherein the first reflective lens and the second reflective lens have different optical powers to produce image planes at different depths.

### CROSS-REFERENCE TO RELATED APPLICATIONS

This application is a National Stage of International Application No. PCT/CN2022/100158, filed on Jun. 21, 2022, which claims priority to U.S. Provisional Application No. 63/212,747, filed on Jun. 21, 2021, both of which are hereby incorporated by reference in their entireties.

### FIELD OF THE INVENTION

The disclosure relates to the technical field of the three-dimensional (3D) displays, and more specifically to an optical display system and an electronics device.

### BACKGROUND OF THE INVENTION

Augmented reality (AR) can be taken as an example of 3D displays. AR is an interactive three-dimensional (3D) experience that overlays digital contents and information onto the physical world. It combines the computer-generated elements with real-world elements with convincing depth, perspective, and other rendering characteristics. A conventional technique to create 3D vision for users is to enhance the illusion of depth in an image by means of stereopsis for binocular parallax. Two physiological factors are involved in perceiving the depth of the virtual 3D objects, including vergence and binocular disparity. In a traditional AR prototype, only one fixed image plane provides the accommodation distance, while the perceived vergence depth varies with the disparity of two images pertaining separately to the left eye and right eye of the viewer. Correspondingly, this raw technology fails to match the vergence and accommodation distance, resulting in visual fatigue, discomfort, and even nausea. With the demand for providing correct focus cues, several methods have been developed, such as light field displays, holographic displays, multi-focal displays, and varifocal displays.

Multi-plane (Multi-focal) displays establish multiple focal depths to match the varying vergence distances perceived by binocular parallax. Recently, Chen, et al. proposed a multi-plane AR display based on cholesteric liquid crystal (CLC) films, which is reported in [Q. Chen, Z. Peng, Y. Li, S. Liu, P. Zhou, J. Gu, J. Lu, L. Yao, M. Wang, and Y. Su, “Multi-plane augmented reality display based on cholesteric liquid crystal reflective films,” Optics Express 27(9), 12039-12047 (2019)]. Circularly polarized lights with opposite handedness offer different optical path lengths through arranging CLC films in different positions. Nonetheless, a beam splitter should be engaged due to the on-axis feature of CLC films. Furthermore, as the number of focal planes increases, additional distances between CLC films should be considered, thereby limiting the design to be a compact display.

### SUMMARY OF THE INVENTION

This disclosure is to provide a new technical solution of an optical display system for providing 3D vision, for example, in an AR system.

According to a first embodiment, there is provided an optical display system, comprising: image-generating display; controllable polarization rotator module, which receives light from the image-generating display and outputs the light into polarized light with a first polarization and/or a second polarization under control; a first reflective lens, which reflects the polarized light with a first polarization to a pupil of an observer; and a second reflective lens, which reflects the polarized light with a second polarization to the pupil, wherein the first reflective lens and the second reflective lens have different optical powers to produce image planes at different depths.

According to a second embodiment, there is provided an electronics device for providing 3D vision, comprising the optical display system according to any of the preceding claims.

According to various embodiments, the vergence-accommodation conflict (VAC) can be at least partially relieved when a user is watching a sequence of 3D images.

Further features of the disclosure and advantages thereof will become apparent from the following detailed description of exemplary embodiments according to the disclosure with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIGS. 1A and 1B show schematic diagrams of an optical display system in accordance with an embodiment.

FIG. 1C shows a simulated standard spot diagrams of the system shown in FIG. 1B.

FIGS. 2A and 2B show schematic diagrams of an optical display system in accordance with another embodiment.

FIG. 2C shows a simulated standard spot diagrams of the system shown in FIG. 2B.

FIGS. 3A and 3B show schematic diagrams of an optical display system in accordance with still another embodiment.

FIG. 3C shows a simulated standard spot diagrams of the system shown in FIG. 3B.

FIG. 4 is a schematic cross-sectional view of an on-axis lens based on a cholesteric liquid crystal pattern.

FIG. 5 is a schematic cross-sectional view of an off-axis lens based on the cholesteric liquid crystal pattern.

FIGS. 6A and 6B show a schematic plane view of controllable polarization rotator modules in off-state and on-state, respectively, in accordance with an embodiment.

FIG. 7 shows a prototype performance of an optical display system implemented with angled on-axis lenses, in accordance with an embodiment.

FIG. 8 shows a schematic diagram of an electronic device according to an embodiment.

### DETAILED DESCRIPTION OF THE EMBODIMENTS

Various exemplary embodiments of the disclosure will now be described in detail with reference to the drawings. It should be noted that the relative arrangement of the components and steps, the numerical expressions, and numerical values set forth in these embodiments do not limit the scope of the disclosure unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

Various provide an optical display system. The optical display system may be a multi-plane display system. It can at least partially relieve the vergence-accommodation conflict (VAC), which occurs while a viewer is viewing a stereoscopic imagery or 3D images or a video.

The optical display system can be used as a multi-plane AR display with custom-designed reflective flat lenses exploiting the time-multiplexing technique. For example, the lenses in the optical display system can be fabricated using patterned CLC polymers, which allows polarization selectivity. The lenses are designed to have different optical powers in response to certain circular polarizations, thereby producing focal planes at different depths.

In an embodiment, an optical display system is provided. The optical display system comprises: image-generating display; controllable polarization rotator module, which receives light from the image-generating display and outputs the light into polarized light with a first polarization and/or a second polarization under control; a first reflective lens, which reflects the polarized light with a first polarization to a pupil of an observer; and a second reflective lens, which reflects the polarized light with a second polarization to the pupil. The first reflective lens and the second reflective lens have different optical powers to produce image planes at different depths.

The image-generating display may be programmable. The reflective lenses with different optical powers in response to certain circular polarization states provide multiple image planes at different depths.

In this embodiment, at least two image planes at different depths can be provided when a viewer is watching a sequence of 3D images. By using the optical display system according to various embodiments, it is possible to change the depth of the image plane so that the viewer can change his accommodative distance. This will at least partially relieve the VAC issue, which can provide a better viewing experience to the viewer.

In an example, the he first reflective lens and the second reflective lens are on-axis reflective flat lenses. For example, the first reflective lens and the second reflective lens are positioned at 22.5° relative to the pupil. In some embodiment, the relative angle could be finely tuned to adapt to specific practical scenarios.

In another example, the optical display system according to claim 2 further comprises a beam splitter. By using a beam splitter, it provides various configurations of optical components, which can provide a freedom of design to a designer. In this way, the designer has more freedom to design a product according to various demands such as cost, user experiences, availability of optical components and so on.

For example, the on-axis reflective flat lenses are positioned parallel to the display. As such, the on-axis reflective flat lenses and the display can be arranged in the same level. This could provide a thin form factor of the final product.

The beam splitter is placed in an optical path between the controllable polarization rotator module and the on-axis reflective flat lenses and directs the light from the on-axis reflective flat lenses to the pupil. For example, the beam splitter transmits the polarized light to the first and/or second reflective lenses and reflects the light from the first and/or second reflective lenses to the pupil.

In still another example, the first and/or second reflective lenses are off-axis flat reflective lenses, and the off-axis flat reflective lenses are positioned parallel to the pupil.

For example, the controllable polarization rotator module converts the light with the first polarization into a polarized light with the second polarization under a converting control and transmits the light with the first polarization without the converting control.

In an example, the image-generating display is a programmable image-generating display. For example, the image-generating display outputs the light with the first polarization. The controllable polarization rotator module converts the light with the first polarization into a polarized light with the second polarization under a converting control.

The controllable polarization rotator module can convert the light from the image-generating display into circularly polarized light. The polarized light with the first polarization is a circularly polarized light with a first handedness, such as right or left handed circularly polarized light. The polarized light with the second polarization is a circularly polarized light with a second handedness, such as left or right handed circularly polarized light.

In an example, wherein the first and/or second reflective lenses have patterned cholesteric liquid crystal.

For example, the first reflective lens is fabricated with a patterned bottom photo-alignment layer and a cholesteric liquid crystal layer placed on the photo-alignment layer. The second reflective lens is fabricated with a patterned bottom photo-alignment layer and a cholesteric liquid crystal layer placed on the photo-alignment layer.

The first reflective lens can be fabricated by a polarization volume holography method. The interference patterns of the first reflective lens can be produced by two circularly polarized light beams. The second reflective lens can also be fabricated by a polarization volume holography method. The interference patterns of the second reflective lens can be produced by two circularly polarized light beams.

The first and second reflective lenses may be stacked together.

For example, the image-generating display is an organic light-emitting diode (OLED) display, a liquid-crystal-on-silicon (LCOS) display or a micro light-emitting diode (μLED) display.

In an example, in inner liquid crystal director distribution of the on-axis reflective flat lens, the liquid crystal directors rotate 360° spatially along helical axis. The distance in which the liquid crystal directors rotate 360° may be a cholesteric liquid crystal pitch. The cholesteric liquid crystal pitch may be twice vertical periodicity of the liquid crystal directors.

In another example, in inner liquid crystal director distribution of the off-axis reflective flat lens, the liquid crystal directors rotate spatially along helical axis.

For example, the helical axis is perpendicular to Bragg surface.

For example, the controllable polarization rotator module includes a liner polarizer, a switchable twisted-nematic (TN) cell and a circular polarizer. An upper substrate and a bottom substrate of the switchable twisted-nematic (TN) cell may be deposited with transparent electrodes.

For example, the transparent electrodes are overcoated with alignment layers in orthogonal directions, thereby twisting liquid crystal directors in the switchable twisted-nematic (TN) cell by 90° when no external electrical field is present or the converting control is not applied.

For example, the direction of the liquid crystal directors is controlled by the amplitude of the external field or the converting control, so as to control the phase retardation acquired by the light.

For example, the circular polarizer converts the linearly polarized light modulated by the liner polarizer and the switchable twisted-nematic (TN) cell into circularly polarized light.

For example, the first reflective lens transmits the polarized light with the second polarization. The second reflective lens transmits the polarized light with the first polarization.

For example, the first and second reflective lens are angled on-axis lenses.

Various embodiments use reflective flat lenses, which are featured with thin form factor, lightweight, polarization selectivity, and potentially tunable reflection band with high efficiency. Stacking the lenses together contributes to compactness. Various embodiments demonstrate diverse system configurations, which could be potentially applied in different practical scenarios.

The reflective lenses in various embodiments can be customized to be implemented in different practical scenarios. Leveraging different optical powers of lenses, multiple focal planes can be established to render the correct focus cues to at least partially relieve the vergence-accommodation conflict when viewing the stereoscopic imagery.

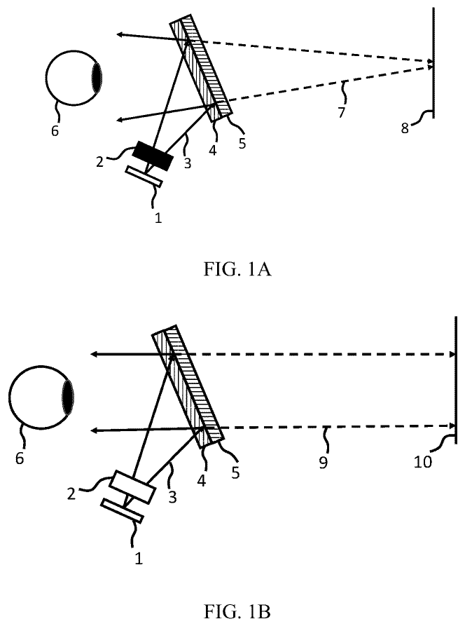

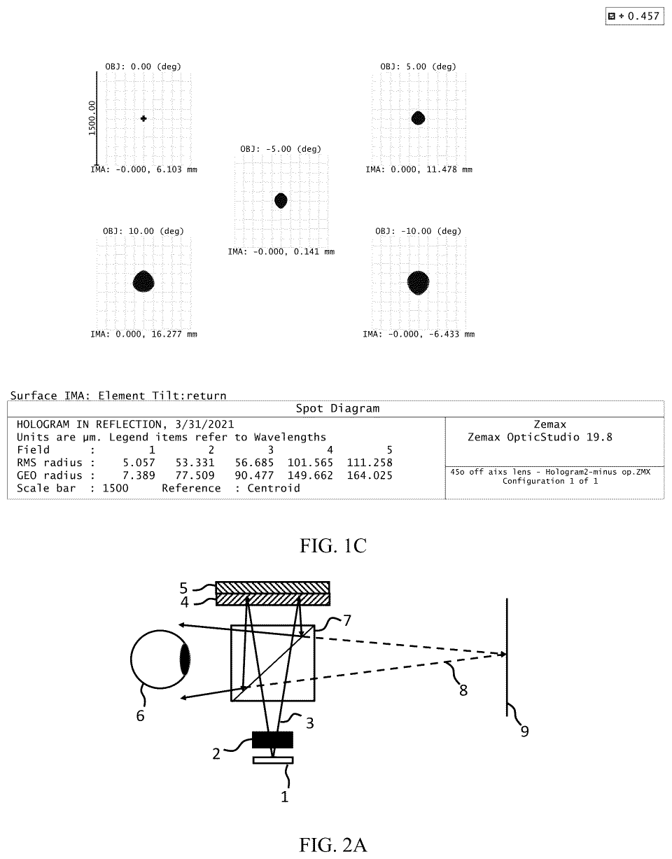

FIGS. 1A and 1B schematically illustrate an optical multi-plane display system implemented with angled on-axis lenses.

The optical display system in FIGS. 1A and 1B includes an image-generating display 1, a controllable polarization rotator module 2, two angled on-axis flat reflective lenses 4 and 5. The reflective lenses 4 and 5 function under circularly polarized light with a certain handedness, respectively. The polarization rotator module 2 has the function to convert the incident light into circularly polarized light with a certain handedness at different switching states. The number of polarization rotator modules and reflective flat lenses is for purpose of description and should not be limiting.

In some embodiments, the display 1 may be an organic light-emitting diode (OLED) display, a liquid-crystal-on-silicon (LCOS) display, a micro light-emitting diode (μLED) display or other display components known in the art. The light emitted from the display 1 passing through the controllable polarization rotator module 2 turns into circularly polarized light 3. The light 3 encounters the reflective lens 4 or reflective lens 5 depending on its polarization state, and then is reflected directly into the observer's pupil 6. Lights 7 and 9 are the extended rays converging in opposite directions, which are focused on image planes 8 and 10 at near depth and far depth, respectively.

FIG. 1C shows the simulated standard spot diagram of the system demonstrated in FIG. 1B. The simulation is performed by OpticStudio software. The optical display system is designed to have an eye relief of 30 mm with a circular FOV of 20° accompanied by a 4-mm eye-box.

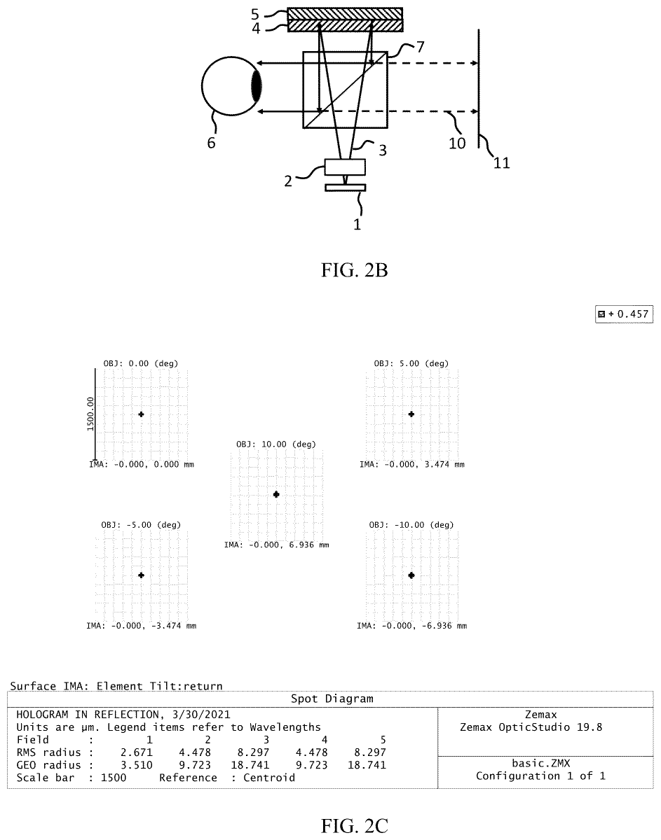

FIGS. 2A and 2B schematically illustrate an optical multi-plane display system implemented with a beam splitter (BS) and on-axis lenses.

The optical display system in FIGS. 2A and 2B includes an image-generating display 1, a controllable polarization rotator module 2, a beam splitter 7, and two on-axis flat reflective lenses 4 and 5. The reflective lenses 4 and 5 function under circularly polarized light with a certain handedness, respectively. The polarization rotator module 2 has the function to convert the incident light into circularly polarized light with a certain handedness at different switching states. The number of polarization rotator modules and reflective flat lenses is for purpose of description and should not be limiting.

In some embodiments, the display 1 may be an organic light-emitting diode (OLED) display, a liquid-crystal-on-silicon (LCOS) display, a micro light-emitting diode (μLED) display or other display components known in the art. The light emitted from the display 1 passing through the controllable polarization rotator module 2 turns into circularly polarized light 3. Then, the light 3 passes through the beam splitter 7 and encounters the reflective lens 4 or lens 5 depending on its polarization state. The light 3 is reflected by one of the reflective lenses and then is reflected by the beam splitter 7 into the observer's pupil 6. Lights 8 and 10 are the extended rays converging in opposite directions, which are focused on image planes 9 and 11 at near depth and far depth, respectively.

FIG. 2C shows the simulated standard spot diagram of the system demonstrated in FIG. 2B. The simulation is performed by OpticStudio software. The system is designed to have an eye relief of 30 mm with a circular FOV of 20° accompanied by a 4-mm eye-box. It can be seen from FIG. 2C that although an extra beam splitter is added, the radiuses of the object at different tilt degrees are kept constant.

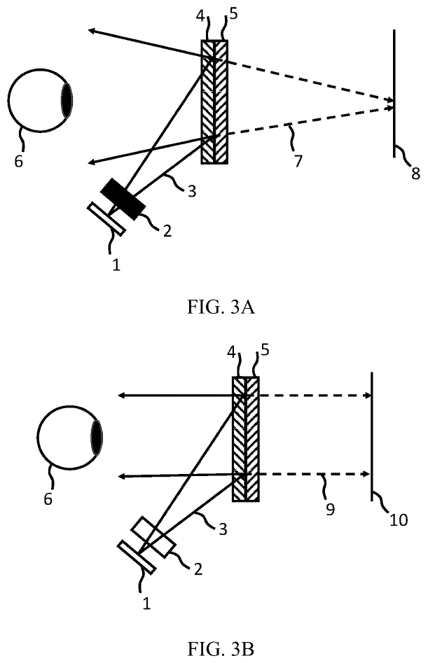

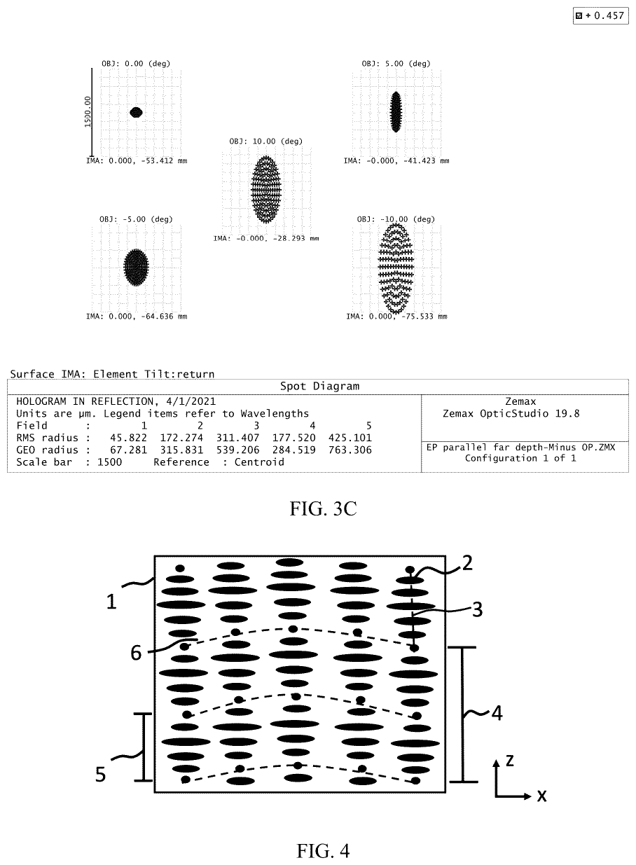

FIGS. 3A and 3B schematically illustrate an optical multi-plane display system implemented with off-axis lenses.

The optical display system in FIGS. 3A and 3B includes an image-generating display 1, a controllable polarization rotator module 2, two off-axis flat reflective lenses 4 and 5. The reflective lenses 4 and 5 function under circularly polarized light with a certain handedness, respectively. The polarization rotator module 2 has the function to convert the incident light into circularly polarized light with a certain handedness at different switching states. The number of polarization rotator modules and reflective flat lenses is for purpose of description and should not be limiting.

In some embodiments, the display 1 may be an organic light-emitting diode (OLED) display, a liquid-crystal-on-silicon (LCOS) display, a micro light-emitting diode (μLED) display or other display components known in the art. The light emitted from the display 1 passing through the controllable polarization rotator module 2 turns into circularly polarized light 3. The light 3 encounters the reflective lens 4 or the reflective lens 5 depending on its polarization state, and then is reflected directly into the observer's pupil 6. Lights 7 and 9 are extended rays converging in opposite directions, which are focused on image planes 8 and 10 at near depth and far depth, respectively.

FIG. 3C shows the simulated standard spot diagram of the system demonstrated in FIG. 3B. The simulation is performed by OpticStudio. The system is designed to have an eye relief of 30 mm with a circular FOV of 20° accompanied by a 4-mm eye-box.

FIG. 4 illustrates the inner liquid crystal director distribution of a local region of on-axis lens 1. In FIG. 4, the liquid crystal directors 2 rotate 3600 spatially along a helical axis 3, where the distance is cholesteric liquid crystal (CLC) pitch 4, which is twice the vertical periodicity 5. The in-plane periodicity (x direction) gets smaller as the distance increases along the radius direction. In some embodiments, the structure of the CLC lens can be achieved with photo-alignment technology. The photo-alignment layer is used to record the bottom pattern. The cholesteric liquid crystal CLC, which naturally forms helical structures, is placed on the photo-alignment pattern to form the structure in FIG. 4. In some embodiments, the structure in FIG. 4 can be directly recorded with polarization volume holography, where a liquid crystal polymer layer is exposed under interfering beams to record the pattern in volume. Line 6 depicts the parabolic phase profile of the lens.

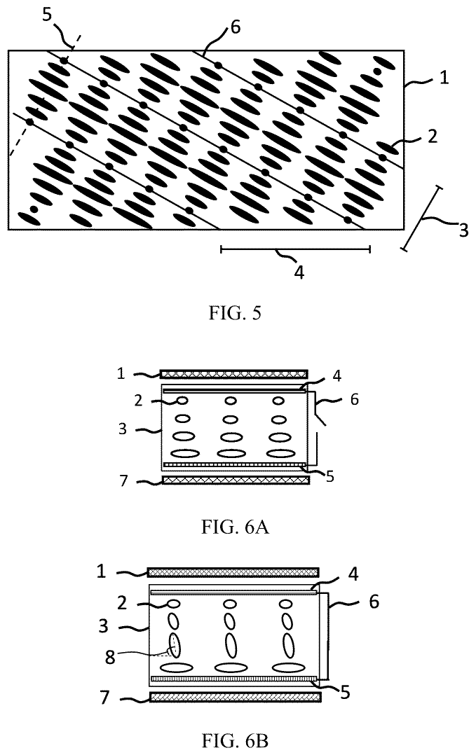

FIG. 5 illustrates the inner liquid crystal molecular structure of a local region of the off-axis lens 1. The liquid crystal LC directors 2 spatially rotate along a helical axis 5, which is perpendicular to Bragg surface 6. The in-plane pattern periodicity 4 is driven by Bragg pitch 3 and position of helical axis 5. In some embodiments, the structure of cholesteric liquid crystal (CLC) lens can be achieved with photo-alignment technology. The photo-alignment layer is used to record the desired pattern. The cholesteric liquid crystal (CLC), which naturally forms helical structures, is placed on the photo-alignment pattern to form the structure in FIG. 5. In some embodiments, the structure in FIG. 5 can be directly recorded with polarization volume holography, where a liquid crystal polymer layer is exposed under interfering beams to record the pattern in volume.

FIGS. 6A and 6B schematically illustrate the arrangement of optical elements composed of the polarization rotator module in the off-state and on-state, respectively. Element 1 is a linear polarizer. Element 3 is a switchable twisted-nematic (TN) cell. The upper and bottom substrates 4 and 5 are deposited with transparent electrodes that, in turn, are overcoated with alignment layers in orthogonal directions, thereby twisting the LC directors 2 by 90° when no external field is present, as shown in FIG. 6A. Element 6 is the switch controller. In the voltage-on state, the LC directors are reoriented to follow the external field, as demonstrated in FIG. 6B. The reorientation angle 8 is determined by the amplitude of the external field. The degree of orientation affects the phase retardation acquired by the transmitted light. Element 7 is a circular polarizer serving to convert the linearly polarized light modulated by elements 1 and 3 into circularly polarized light. In some embodiments, the structure of the polarization rotator module is not limited to what we have described here.

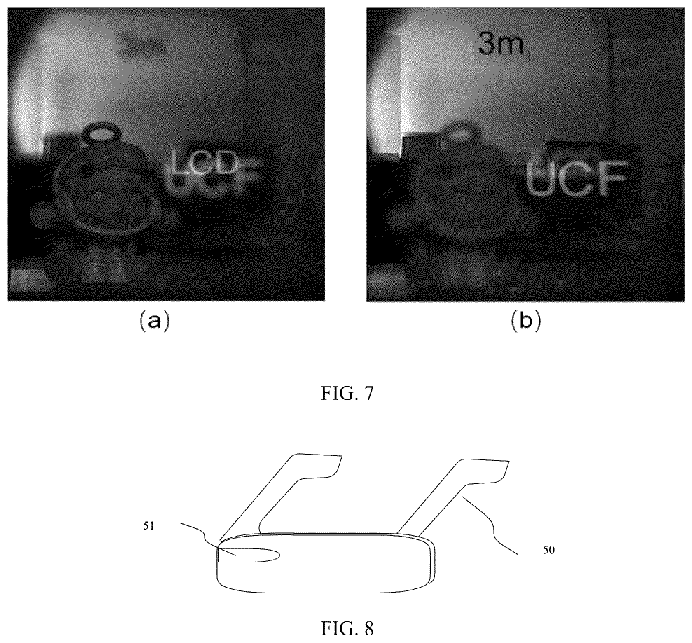

FIG. 7 shows the prototype performance of the optical display system implemented with angled on-axis lenses, as depicted in FIGS. 1A and 1B. Two real objects were positioned at 25 cm and 3 m, respectively. The display was placed at around 6.5 cm away from the two stacked flat reflective lenses. The flat reflective lenses are designed to have different optical powers. Then, the polarization rotator module and the computer-generated images are simultaneously switched to create two image planes. A camera was positioned at about 3 cm in front of the lenses to capture images. As shown in FIG. 7, when the camera is focused at the near depth, both the doll and ‘LCD’ image looked clear, while the far objects and ‘UCF’ image are strongly blurred. On the contrary, when the camera is focused at the far depth, both objects on the wall and ‘UCF’ image could be clearly focused at far depth, while the doll and ‘LCD’ image are strongly blurred. The different sizes of virtual images are caused by the different magnifications at two depths.

FIG. 8 shows a schematic diagram of an electronic device according to an embodiment. The electronic device 50 can be an AR glass which can provide a 3D vision. The electronic device 50 includes an optical display system 51 as described above. The optical display system 51 can at least partially relieve the VAC issue when a viewer is watching a sequence of 3D images.

Although some specific embodiments of the disclosure have been demonstrated in detail with examples, it should be understood by a person skilled in the art that the above examples are only intended to be illustrative but not to limit the scope of the disclosure.

1. An optical display system, comprising:
an image-generating display;
a controllable polarization rotator module, configured to receive light from the image-generating display and output polarized light with a first polarization and/or a second polarization under control;
a first reflective lens, configured to reflect the polarized light with a first polarization to a pupil of an observer; and
a second reflective lens, configured to reflect the polarized light with a second polarization to the pupil,
wherein the first reflective lens and the second reflective lens have different optical powers to produce image planes at different depths.

2. The optical display system according to claim 1, wherein the first reflective lens and the second reflective lens are on-axis reflective flat lenses.

3. The optical display system according to claim 2, wherein the first reflective lens and the second reflective lens are positioned at 22.5° relative to the pupil.

4. The optical display system according to claim 2, further comprising:
a beam splitter.

5. The optical display system according to claim 4, wherein the on-axis reflective flat lenses are positioned parallel to the display.

6. The optical display system according to claim 5, wherein the beam splitter is placed in an optical path between the controllable polarization rotator module and the on-axis reflective flat lenses and directs the light from the on-axis reflective flat lenses to the pupil.

7. The optical display system according to claim 6, wherein the beam splitter transmits the polarized light to the first and/or second reflective lenses and reflects the light from the first and/or second reflective lenses to the pupil.

8. The optical display system according to claim 1, wherein the first and/or second reflective lenses are off-axis flat reflective lenses, and the off-axis flat reflective lenses are positioned parallel to the pupil.

9. The optical display system according to claim 1, wherein at least one of the first reflective lens and the second reflective lens is fabricated with a patterned bottom photo-alignment layer and cholesteric liquid crystal placed on the photo-alignment layer.

10. The optical display system according to claim 1, wherein the controllable polarization rotator module converts the light with the first polarization into a polarized light with the second polarization under a converting control and transmits the light with the first polarization without the converting control.

11. An electronics device for providing 3D vision, comprising an optical display system according to claim 1.
